(19) United States
(12) Patent Application Publication
(10) Pub. No.: US 2005/0130537 A1
(43) Pub. Date: Jun. 16, 2005

(54) Vehicle seat cover

(75) Inventor: Stephen L. Phelps, Lilburn, GA (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/735,459

(22) Filed: Dec. 12, 2003

(51) Int. Cl. B32B 5/02

(52) U.S. Cl. 442/327

(57) ABSTRACT

A washable, stain-resistant vehicle seat cover, which includes an upper portion configured to cover a portion of a backrest. The seat cover also has a lower portion configured to cover a portion of a seat cushion. A first and second elasticized flap is included. Each flap is positioned near a lateral edge of a junction of a backrest and a seat cushion. The flaps cooperate to define a containment area therebetween.

### BACKGROUND OF THE INVENTION

This invention pertains to a vehicle seat cover used to protect a covering on a vehicle seat. More specifically, this invention relates to a washable, economical vehicle seat cover.

Vehicle seats, such as car seats, are prone to getting spills and stains. Even if a car seat is made at least partially from a plastic or polymer-type material, such material may still be stained by items dropped and spilled in the seat by passengers.

Currently, seat covers for car seats, if they are washable or dry cleanable, are often made from a heavy, expensive material. Such material is required in a seat cover that is used every day for many days. Often such heavy, expensive seat covers retain stains after being washed or dry-cleaned, even if pre-treated with a stain retardant. The seat cover then becomes unsightly, due to repeated stains that are retained by the material.

Other, temporary seat covers for automobiles and vehicles are made from a lightweight plastic film. Such seat covers, while providing temporary protection, do not provide any absorption of liquids, and so forth. In addition, light-weight plastic seat covers are often not tear resistant, and therefore do not hold up to repeated day-after-day usage. Therefore, such temporary seat covers last for only a single or few uses before they must be discarded.

A light-weight, washable, stain-resistant car seat cover, which is inexpensive for every day use would be desirable. Such a car seat cover may be used and washed a few times, and then, due to its low cost, discarded. Alternatively, such a car seat cover would be durable enough to last through more than several washings, and would be stain-resistant as well.

Such a car seat cover may have some absorbency qualities, such that liquids are absorbed into the car seat cover, and not spilled onto passengers or the floor of the vehicle. Further, such a car seat cover may also have some elasticized side flaps, to assist in keeping items spilled into the car seat cover from spilling onto other occupants or other areas of the vehicle. Moreover, the elasticized side flaps may provide barriers as well as a containment area to hold items spilled into the car seat cover in place.

Definitions

(a) “Air permeable” or “Breathable” means fabrics which are capable of acting as a barrier to particulate matter, water, and other liquids yet which allow water vapor and air to pass therethrough. Such fabrics may be referred to as “breathable barriers.” Articles or products made using breathable fabrics are generally more comfortable to wear or use since the migration of water vapor through the fabric helps to reduce and/or eliminate discomfort resulting from excess moisture trapped against the skin.

(b) “Bonded carded fabric or web”, “bonded carded web”, and “bonded carded fabric” refer to fabric or webs made from staple fibers which are sent through a combing or carding unit, which individualizes and aligns the staple fibers in the machine direction to form a generally machine direction-oriented fibrous nonwoven web. Such fibers are usually purchased in bales which are placed in a picker which separates the fibers prior to the carding unit. Once the web or fabric is formed, it is then bonded by one or more of several known bonding methods. One such bonding method is powder bonding, wherein a powdered adhesive is distributed through the web or fabric and then activated, usually by heating the fabric and adhesive with hot air. Another suitable bonding method is pattern bonding, wherein heated calendar rolls or ultrasonic bonding equipment are used to bond the fibers together, usually in a localized bond pattern, though the fabric can be bonded across its entire surface if so desired. Another suitable and well-known bonding method, particularly when using bi-component staple fibers, is through-air bonding.

(c) “Cross machine direction” (“CD”) means the direction or axis of the product or material generally perpendicular to the machine direction.

(d) “Disposable” includes being discarded of after use, and not intended to be washed and reused.

(e) “Fabric” is used to refer to all of the woven, knitted, and nonwoven webs.

(f) “Flexible” refers to materials or fabrics that are compliant and readily conform to the general shape and contours of an individual's body.

(g) “Gatherable” material is one which, when bonded to a web with the latter under tension, will gather, with the formation of puckers or gathers, to accommodate contraction of the web upon release of the tensioning forces.)

(h) “Hydrophilic” describes fibers or surfaces of fibers that are wetted by the aqueous liquids in contact with the fibers. The degree of wetting of the materials can be described in terms of contact angles and the surface tensions of the liquids and materials involved. Equipment and techniques suitable for measuring the wettability of particular fiber materials or blends of fiber materials can be provided by a Cahn SFA-222 Surface Force Analyzer System. When measured with this system, fibers having contact angles less than 90° are designated “wettable”, i.e., “hydrophilic”, and fibers having contact angles greater than 90° are “nonwettable”, i.e., “hydrophobic”.

(i) “Joining”, “join”, “joined”, “connect”, connected”, or variations thereof, when used describing the relationship between two or more elements, means that the elements can be connected together in any suitable manner, such as by heat sealing, ultrasonic bonding, thermal bonding, adhesives, stitching, or the like. Further, the elements can be joined directly together, or may have one or more elements interposed between them, all of which are connected together. The elements can be permanently or refastenably joined together.

(j) “Machine direction” (“MD”) means the direction in which the product or material is produced or the axis of the fabric corresponding to the direction of the machine operations.

(k) “Meltblown fibers” means fibers formed by extruding a molten thermoplastic material through a plurality of fine, usually circular, die capillaries as molten threads or filaments into converging high velocity, usually hot gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example in U.S. Pat. No. 3,849,241 issued to Butin et al. which is incorporated herein by reference. Meltblown fibers are microfibers which may be continuous or discontinuous, are generally smaller than 10 microns in average diameter, and are generally tacky when deposited onto a collecting surface.

(l) “Multi-layer laminate” means a laminate wherein some of the layers are spunbond and some are meltblown having a configuration such as spunbond/meltblown/spunbond (SMS) laminate and others as disclosed in U.S. Pat. No. 4,041,203 issued to Brock et al.; U.S. Pat. No. 5,169,706 issued to Collier et al.; U.S. Pat. No. 5,145,727 issued to Potts et al.; U.S. Pat. No. 5,178,931 issued to Perkins, et al.; and, U.S. Pat. No. 5,188,885 issued to Timmons et al., all of which are incorporated herein by reference. Such a laminate may be made by sequentially depositing onto a moving forming belt first a spunbond fabric layer, then a meltblown fabric layer and last another spunbond layer and then bonding the laminate in a manner described below. Alternatively, the fabric layers may be made individually, collected in rolls, and combined in a separate bonding step. Such fabrics usually have a basis weight of from about 0.1 osy to about 12 osy (6 to 400 gsm), or more particularly from about 0.75 osy to about 3 osy. Multi-layer laminates may also have various numbers of meltblown layers or multiple spunbond layers in may different configurations and may include other materials like films or coform materials.

(m) “Nonwoven fabric or web”, “nonwoven web”, and “nonwoven fabric” mean a web having a structure of individual fibers or threads which are interlaid, but not in an identifiable manner as in a knitted fabric. Nonwoven fabrics or webs have been formed from many processes such as, for example, meltblowing processes, spunbonding processes, and bonded carded web processes. The basis weight of nonwoven fabrics is usually expressed in ounces of material per square yard (osy) or grams per square meter (gsm) and the fiber diameters are usually expressed in microns.

(n) “Polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configuration of the material. These configurations include, but are not limited to isotactic, syndiotactic and random symmetries.

(o) “Spunbonded fibers” refers to small diameter fibers which are formed by extruding molten thermoplastic material as filaments from a plurality of fine, usually circular capillaries or spinneret with the diameter of the extruded filaments then being rapidly reduced as methods discussed, for example, in U.S. Pat. No. 4,340,563 issued to Appel et al.; U.S. Pat. No. 3,692,618 issued to Dorschner et al.; U.S. Pat. No. 3,802,817 issued to Matsuki et al.; U.S. Pat. Nos. 3,338,992 and 3,341,394 issued to Kinney; U.S. Pat. No. 3,502,763 issued to Hartman; and, U.S. No. Pat. No. 3,542,615 issued to Dobo et al., all of which are incorporated herein by reference. Spunbond fibers are generally not tacky when they are deposited onto a collecting surface. Spunbond fibers are generally continuous and have average diameters (from a sample of at least 10) larger than about 7 microns, more particularly, between about 10 and about 20 microns.

(p) “Stitchbonded” means, for example, the stitching of a material in accordance with U.S. Pat. No. 4,891,957 issued to Strack et al. or U.S. Pat. No. 4,631,933 issued to Carey, Jr, all of which are incorporated herein by reference.

(q) “Stretch bonded laminate” (“SBL”) refers to a composite material having at least two layers in which one layer is a gatherable layer and the other layer is a stretchable, that is, elastic, layer. The layers are joined together when the stretchable layer is in a stretched condition so that upon relaxing the layers, the gatherable layer is gathered.

(r) “Thermal point bonding” involves passing a fabric or web of fibers to be bonded between a heated calender roll and an anvil roll. The calender roll is usually, though not always, patterned in some way so that the entire fabric is not bonded across its entire surface. As a result, various patterns for calender rolls have been developed for functional as well as aesthetic reasons. One example of a pattern has points and is the Hansen pattern with about a 30% bond area with about 200 bonds/square inch as taught in U.S. Pat. No. 3,855,046 issued to Hansen et al. The Hansen pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5%. Another typical point bonding pattern is the expanded Hansen bond pattern which produces a 15% bond area with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15%. Yet another common pattern is the C-Star pattern which has a bond area of about 16.9%. The C-Star pattern has a cross-directional bar or “corduroy” design interrupted by shooting stars. Other common patterns include a diamond pattern with repeating and slightly offset diamonds and a wire weave pattern looking as the name suggests, e.g. like a window screen. Typically, the percent bonding area varies from around 10% to around 30% of the area of the fabric laminate web. As in well known in the art, the spot bonding holds the laminate layers together as well as imparts integrity to each individual layer by bonding filaments and/or fibers within each layer.

(s) “Through air bonding” (“TAB”) means a process of bonding a nonwoven bicomponent fiber web in which air which is sufficiently hot to melt one of the polymers of which the fibers of the web are made is forced through the web. The air velocity is between 100 and 500 feet per minute and the dwell time may be as long as 6 seconds. The melting and resolidification of the polymer provides the bonding. Through air bonding has restricted variability and is generally regarded a second step bonding process. Since TAB requires the melting of at least one component to accomplish bonding, it is restricted to webs with two components such as bicomponent fiber webs.

(t) “Ultrasonic bonding” means a process performed, for example, by passing the fabric between a sonic horn and anvil roll as illustrated in U.S. Pat. No. 4,374,888 issued to Bornslaeger.

These definitions are not intended to be limiting and these terms may be defined with additional language in the remaining portion of the specification.

### SUMMARY OF THE INVENTION

In response to the difficulties and problems discussed above, a washable, stain-resistant seat cover is provided, which includes an upper portion configured to cover a portion of a backrest. The seat cover also has a lower portion configured to cover a portion of a seat cushion. A first and second elasticized flap is included. Each flap is positioned near a lateral edge of a junction of a backrest and a seat cushion. The flaps cooperate to define a containment area therebetween.

### BRIEF DESCRIPTION OF THE DRAWINGS

FIG. 1 is a schematic perspective view of an embodiment of a vehicle seat cover, showing the seat cover extending over a portion of a backrest, a head rest, and a seat cushion of a vehicle seat, side flaps positioned at the lateral edges of the junction between the backrest and the seat cushion, providing a containment area;

FIG. 2 is a schematic side view of an embodiment of the vehicle seat cover of FIG. 1;

FIG. 3 is a schematic top plan view of a front side of the vehicle seat cover of FIGS. 1 and 2 when not positioned on a vehicle seat, showing a pair of spaced-apart curved flaps;

FIG. 4 is a schematic top plan view of the back side of the vehicle seat cover of FIGS. 1 and 2 when not positioned on a vehicle seat, showing the pockets which extend over the headrest, a portion of the backrest and the seat cushion;

FIG. 5 is a schematic partial top plan view of another embodiment of a vehicle seat cover, showing longitudinally straight flaps with two elastic members in each flap;

FIG. 6 is a schematic partial top plan view a another embodiment of a vehicle seat cover, showing two elasticized flaps positioned on and bonded to a portion of the vehicle seat cover;

FIG. 7 is a cross sectional view of one embodiment of the vehicle seat cover, showing a single layer; and

FIG. 8 is a cross sectional view of another embodiment of the seat cover, showing two layers.

### DETAILED DESCRIPTION

Reference will now be made in detail to one or more embodiments of the invention, examples of which are illustrated in the drawings. Each example and embodiment is provided by way of explanation of the invention, and is not meant as a limitation of the invention. For example, features illustrated or described as part of one embodiment may be used with another embodiment to yield still a further embodiment. It is intended that the invention include these and other modifications and variations as coming within the scope and spirit of the invention.

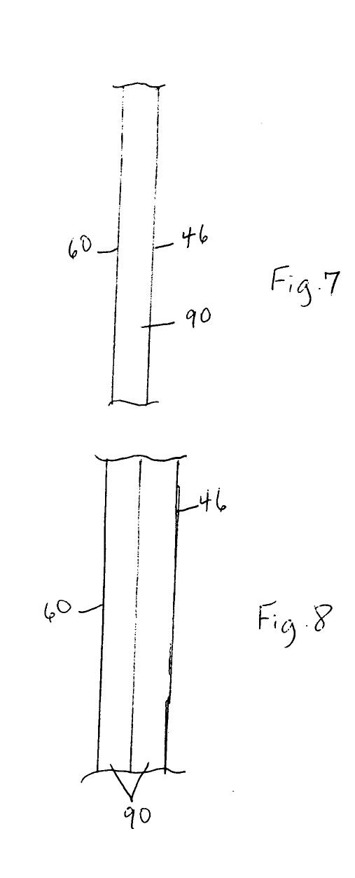

Referring to FIGS. 1-4, a vehicle seat cover or seat cover 10 is provided for a vehicle seat 12 which has a backrest 14, a seat cushion 16, and, optionally, a head rest 18. The seat cover 10 is desirably formed from a web of fabric or sheet material. The seat cover 10 may be formed from a web of fabric or sheet material having one layer (FIG. 7), two layers (FIG. 8), or a plurality of layers (not shown).

The seat cover 10 includes an upper portion 20 configured to cover a portion 22 of the backrest 14 which would contact a passenger's or driver's (hereinafter collectively “occupant” or “occupant's”) back, and a portion of the head rest 18. The seat cover 10 also includes a lower portion 24 configured to cover a portion of the seat cushion 16 which would contact an occupant's buttocks. A pair of elasticized flaps, that is, a first elasticized flap 26 and a second elasticized flap 28 are positioned in a spaced apart configuration on a front side 30 of the seat cover 10. When the seat cover 10 is positioned over the backrest 14, head rest 18 and seat cushion 16, as shown in FIGS. 1 and 2, each of the flaps 26, 28 is positioned near a lateral edge 32 of a portion of the underlying backrest 14 and seat cushion 16, and adjacent a junction 34 of the backrest 14 and the seat cushion 16.

The flaps 26, 28 cooperate to define a containment area 36 at the junction 34 and in a lower end 38 of the upper portion 20 of the seat cover 10 as well as the back end 40 of the lower portion 24 of the seat cover 10. The containment area 36 is designed to contain liquid, such as, for example, soft drinks, and/or solids, such as, for example, cookie crumbs. In this manner, liquids and solids may be kept from being spread further throughout the vehicle, or onto other occupants and/or articles in the vehicle, and so forth.

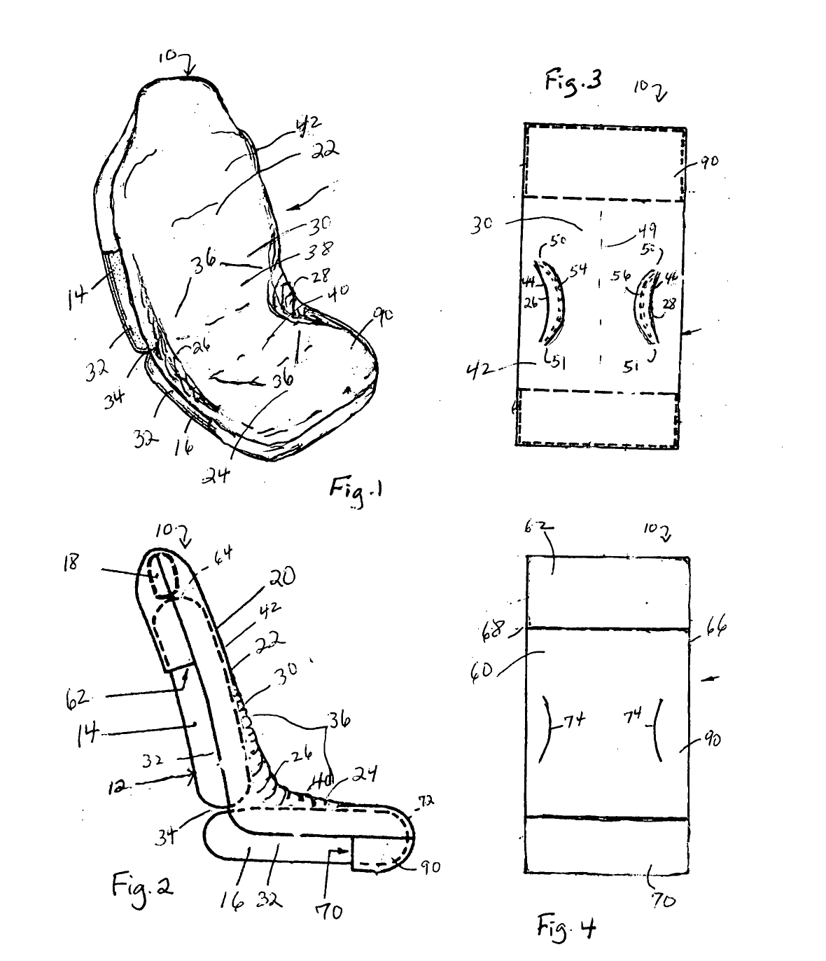

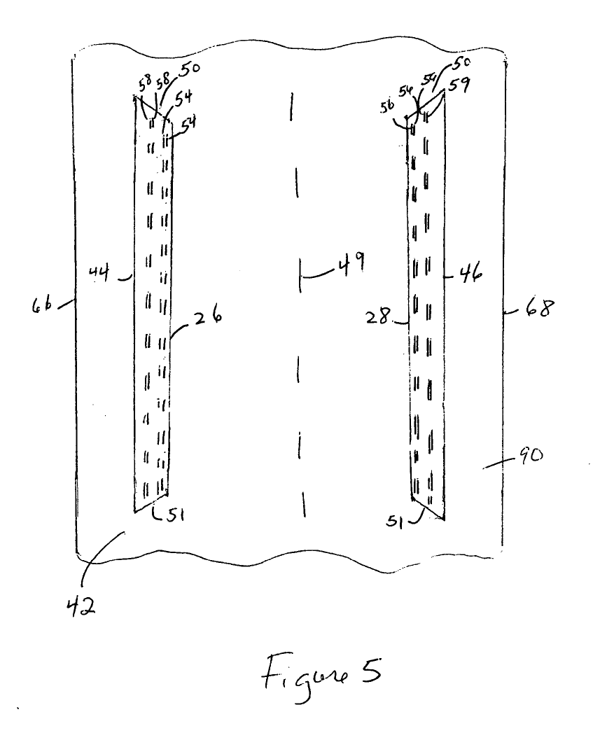

A schematic illustration of the seat cover 10 when positioned flat is shown in FIGS. 3 and 4. The seat cover 10 may desirably be formed from one piece of fabric or sheet material. Alternatively, two or more pieces of fabric or sheet material may be connected together by sewing, ultrasonic bonding, adhesive bonding, and so forth to provide the seat cover 10. A front side 42 includes the flaps 26, 28 which are attached to or formed from the front side 42 along lines 44, 46, respectively. Creases providing gathered fabric formed along lines 44, 46 may be joined or “sealed” by, for example, a continuous sonic bond, by a strip of adhesive, and/or by sewing or stitching the crease in place, and so forth. The sealing of the creases increases the ability of the structure (flaps 26, 28) to maintain its shape and increases containment of liquids or solids spilled therein. Alternatively, the creases can consist of a series of spotbonds 48 (FIG. 6).

The flaps 26, 28 are attached to, or formed from at least the front side 42 of the seat cover 10; the flaps 26, 28 may be formed from the same fabric, or, alternatively, the flaps 26, 28 may be formed from a different fabric. The flaps 26, 28 may be formed at least partially from a liquid impervious material. The flaps 26, 28 may be folded inward toward a centerline 49 and bonded at each end 50, 51, respectively, to the front side 42 of the seat cover 10 (FIGS. 3, 5 and 6). Such bonds may be continuous or spot bonds 48 (FIG. 6). Flaps 26, 28 form barriers which desirably block movement of liquids or solids in the containment area 36.

The flaps 26, 28 each have at least one elastic member or elasticized member 54, 56 provided therein or applied thereto. The elasticized members 54, 56 may be applied essentially at the inwardly directed edge of flaps 26, 28. One method of imparting elasticity to the flaps 26, 28 is by extruding a hot melt pressure-sensitive elastomeric adhesive, such as that marketed by H.B. Fuller Co., St, Paul, Minn., under the trademark FULLASTIC®. In addition, the elasticized members 54, 56 may comprise any elastic string, ribbon, and so forth, and may be stitched, sonically welded, adhered, and so forth, to the flaps 26, 28. Further, the elasticized members 54, 56 may also comprise a thin ribbon of natural rubber.

The elasticized members 54, 56 are tensioned or biased so that the flaps 26, 28 are laid flat as illustrated in FIG. 3. However, when the seat cover 10 is positioned on a vehicle seat 12, as shown in FIGS. 1 and 2, the elasticized members 54, 56 support the flaps 26, 28 in an upright position, to provide barriers which assist in defining the containment area 36, to assist in holding liquids and/or solids within the containment area 36.

As shown in FIG. 4, on a back side 60 of the seat cover 10, a first pocket 62 is provided which covers an upper end 64 of the backrest 14 and a substantial portion of the headrest 18 as well. The first pocket 62 is formed when edges 66, 68 of the seat cover 10 are overlapped and joined or connected together. A second pocket 70 is provided as well, which covers a front end 72 of the seat cushion 16, and is formed in a manner similar to the first pocket 62 such that edges 66, 68 are joined together. The creases are represented by a line 74 showing where the web of fabric or sheet material is gathered and joined to provide the flaps 26, 28. While pockets 62, 70 are shown which assist in holding the seat cover 10 in place and positioned over at least a portion of the backrest 14, and head rest 18 and the seat cushion 16.

It will be appreciated that other apparatus and/or other designs may be used to provide a seat cover 10. The seat cover 10 may take any shape, and the present example is but just one example thereof; many other shapes are known in the art. The shape of the seat cover 10 may therefore include any shape or configuration which operates as shown and/or described herein, or known in the art. That is, for example, one or more drawstrings and/or one or more elastic strings (not shown) may be used to hold the seat cover 10 to the backrest 14, head rest 18, and seat cushion 16, without the need to form pockets. Further, one or more hook and loop materials, snaps, buttons and button holes, clips, or other fasteners known in the art (not shown) may also be used to hold the seat cover in place. Moreover, any elasticized members shown and/or described herein may be used as well. Therefore, it will be understood that the pockets 62, 70 are shown as merely one non-limiting embodiment.

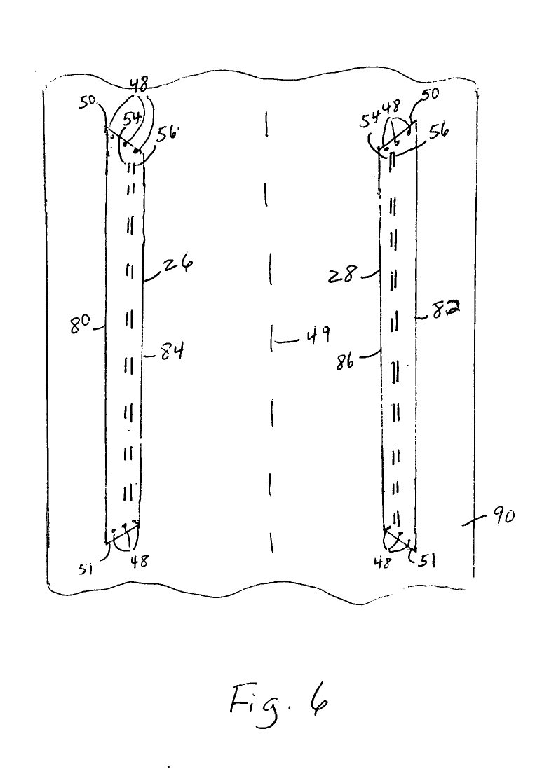

Referring to FIG. 5, the flaps 26, 28 are shown in an alternative embodiment, with each flap 26, 28 having a generally straight, uncurved and longitudinal configuration and having at least a second elasticized member 58, 59 disposed on and/or sewn or otherwise joined or bonded into each flap 26, 28. The second elasticized member 58, 59 is applied to each flap 26, 28 intermediate to the first elasticized members 54, 56 and the lines 44, 46, respectively. The first elasticized members 54, 56 in each flap 26, 28 are applied with a first preselected tension sufficient to cause each flap 26, 28 to be positioned at an angle of about 25 degrees to about 120 degrees with respect to the material at the centerline 49, when positioned on a vehicle seat as shown in FIGS. 1 and 2. Desirably, the angle of each flap 26 with respect to the centerline 49 is in a range of about 40 degrees to about 100 degrees. Even more desirably, the angle of each flap 26 with respect to the centerline 49 is about 45 degrees to about 95 degrees. The second elasticized members 54, 56, when used, are provided with a second preselected tension which may be greater than, less than, or equal to the first preselected tension. While a pair of flaps 26, 28 is shown, it will be appreciated that this illustration is non-limiting; and that more than two flaps may be provided with the seat cover 10. Similarly, more than two elasticized members may be provided as well (not shown).

FIG. 6 illustrates an alternative embodiment of the present invention showing flaps 26, 28 extending longitudinally in generally straight lines, similar to the embodiment shown in FIG. 5, except that each flap 26, 28 only has one elasticized member 54, 56. Flaps 26, 28 are formed separately from the seat cover 10 and are disposed on and at least partially bonded to the front side 42 of the seat cover 10 and joined along edges 80, 82, providing free edges 84, 86 which, when the seat cover 10 is positioned on a vehicle seat 12, provide barriers and a containment area 36 similar to those shown by flaps 26, 28 in FIGS. 1 and 2.

The car seat 10 may be formed from one or a variety of materials or fabrics. The following description of materials or fabrics may provide the front side 42, the back side 60, and/or the flaps 26, 28 of the seat cover 10.

A web of fabric 90 used to provide the seat cover 10 may be any suitable material, such as a woven material, a nonwoven material, a fibrous or a polymeric film material and may be, although they need not necessarily be, an elastic material or of a stretchable nature. Suitable fibrous webs or sheet materials may utilize any suitable natural and/or synthetic fibers, for example, woven or nonwoven webs of fibers made of acrylic polymers, polyester, polyamide, rayon, glass, polyolefins, e.g., polyethylene and polypropylene, cellulosic derivatives such as cotton, silk, wool, pulp, paper, and the like, as well as blends or combinations of any two or more of the foregoing. The web of fabric 90 may also comprise polymeric film layers such as polyethylene, polypropylene, polyamide, polyester, acrylic polymers, and compatible mixtures, blends, and copolymers thereof.

The web of fabric 90 may be liquid pervious, permitting liquids to readily penetrate into its thickness, or impervious, resistant to the penetration of liquids into its thickness. The web of fabric 90 may also be constructed such that it is breathable, non-breathable, or a combination thereof. The web of fabric 90 may be made from a wide range of materials, such as natural fibers (e.g. wood or cotton fibers), synthetic fibers (e.g. rayon, polyester or polypropylene fibers), or from a combination of natural and synthetic fibers or reticulated foams and apertured plastic films. The web of fabric 90 may be woven, nonwoven, or film such as spunbonded, carded, or the like. A suitable web of fabric 90 may carded, and thermally bonded by means well known to those skilled in the fabric art.

Alternatively, the web of fabric 90 may be derived from a spunbonded web. In a desired embodiment, the web of fabric 90 is spunbonded polypropylene nonwoven, meltblown polypropylene nonwoven, and spunbonded polypropylene nonwoven laminate (SMS). The total basis weight is from about 0.15 osy to about 8.0 osy (more desirably 2.8 osy) and is made with about 86% spunbonded nonwoven and 14% meltblown nonwoven. A pigment such as titanium dioxide may be incorporated into the web of fabric 90. Such a spunbonded meltblown nonwoven laminate material is available from Kimberly-Clark Corporation, Roswell, Ga. The basis weight of the SMS material may vary from about 0.4 osy to about 1.0 osy.

In other desired embodiments, the web of fabric 90 is spunbonded polypropylene nonwoven with a wire-weave bond pattern having a grab tensile of 19 pounds as measured by ASTM D1682 and D1776, a Taber 40 cycle abrasion rating of 3.0 as measured by ASTM D1175 and Handle-O-Meter MD value of 6.6 grams as measured by the INDA standard test 1^{st} 90.0-75(R82) and CD value of 4.4 grams using TAPPI method T402. Such a spunbonded material is available from Kimberly-Clark Corporation, Roswell, Ga. The web of fabric 90 has a weight of from about 0.5 osy to about 2.5 osy, desirably about 1.5 osy.

The web of fabric 90 may be constructed of a single spunbonded polypropylene nonwoven web having a basis weight of about 0.5 osy (17 gsm) to about 1.5 osy (51 gsm). In the structure of the seat cover 10, the web of fabric 90 desirably comprises a material having a basis weight of from about 0.5 osy (17 gsm) to about 1.5 osy (51 gsm). Lesser or greater basis weights may be used in the other regions of the seat cover 10, such as the edges portion 92 overlying the seat cushion, or any other portions of the seat cover 10. Additionally, the web of fabric 90 or portions thereof, can be made of materials having an abrasion resistant characteristic.

The web of fabric 90 may be any soft and flexible sheet. The web of fabric 90 may permit submersion in liquids, such as fresh water, salt water, and/or treated water (chlorinated or brominated) and still retain its integrity. The web of fabric 90 may comprise, for example, a nonwoven web or sheet of a spunbonded, meltblown, or bonded-carded web composed of synthetic polymer filaments, such as polypropylene, polyethylene, polyesters, or the like, or a web of natural and synthetic fibers or filaments such as cotton and rayon. The web of fabric 90 may be selectively embossed or perforated with discrete slits or holes extending therethrough.

The web of fabric 90 may be further dyed, pigmented, or imprinted with any suitable color. Desirably, the web of fabric 90 is dyed, pigmented, or printed with a material which does not irritate or bleed the color onto the skin of the user. The web of fabric 90 may be naturally hydrophobic or may be treated to make it hydrophobic if so desired.

For embodiments wherein the web of fabric 90 is a multi-layer laminate or structure, at least the front side 42 is desirably compliant and soft feeling to the user. The back side 60 and the front side 42, in a multi-layer structure may be bonded together by any method known in the art, including but not limited to, ultrasonic bonding, sewing, stitched bonding, adhesives, thermal bonding, and heat sealing. The following description of materials from which the back side 60 may be formed may also be used to form the material of the front side 42.

The back side 60 may be any suitable gatherable material, such as a woven material, a nonwoven material, and a fibrous or a polymeric film material and may be, although they need not necessarily be, an elastic material or of a stretchable nature. Suitable fibrous gatherable webs may utilize any suitable natural and/or synthetic fibers, for example, woven or nonwoven webs of fibers made of acrylic polymers, polyester, polyamide, rayon, glass, polyolefins, e.g., polyethylene and polypropylene, cellulosic derivatives such as cotton, silk, wool, pulp, paper, and the like, as well as blends or combinations of any two or more of the foregoing. The gatherable webs may also comprise polymeric film layers such as polyethylene, polypropylene, polyamide, polyester, acrylic polymers, and compatible mixtures, blends, and copolymers thereof.

The back side 60 may be liquid pervious, permitting liquids to readily penetrate into its thickness, or impervious, resistant to the penetration of liquids into its thickness. The back side 60 may be made from a wide range of materials, such as natural fibers (e.g. wood or cotton fibers), synthetic fibers (e.g. rayon, polyester, or polypropylene fibers), or from a combination of natural and synthetic fibers or reticulated foams and apertured plastic films. The back side 60 may be woven, nonwoven, or film such as spunbonded, carded, or the like. A suitable material of web of fabric for the back side 60 may be carded, and thermally bonded by means well known to those skilled in the fabric art.

Alternatively, the back side 60 may be derived from a spunbonded web. In a desired embodiment, the back side 60 is spunbonded polypropylene nonwoven, meltblown polypropylene nonwoven and spunbonded polypropylene nonwoven laminate (SMS). The total basis weight is from about 0.3 osy to about 4.0 osy (more desirably 1.5 osy) and is made with about 86% spunbonded nonwoven and 14% meltblown nonwoven. A pigment such as titanium dioxide may be incorporated into the back side 60 and/or the front side 42. Such spunbonded meltblown nonwoven laminate material is available from Kimberly-Clark Corporation, Roswell, Ga. The basis weight of the SMS material may vary from about 0.4 osy to about 1.0 osy.

In other desired embodiments, the back side 60 is spunbonded polypropylene nonwoven with a wire-weave bond pattern having a grab tensile of 19 pounds as measured by ASTM D1682 and D1776, a Taber 40 cycle abrasion rating of 3.0 as measured by ASTM D1175 and Handle-O-Meter MD value of 6.6 grams as measured by the INDA standard test 1^{st} 90.0-75(R82) and CD value of 4.4 grams using TAPPI method T402. Such spunbonded material is available from Kimberly-Clark Corporation, Roswell, Ga. The back side 60 has a weight of from about 0.5 osy to about 2.5 osy, desirably about 1.5 osy.

The back side 60 may be constructed of a single spunbonded polypropylene nonwoven web having a basis weight of about 0.5 osy (17 gsm) to about 1.5 osy (51 gsm). In the structure of the seat cover 10, the back side 60 desirably comprises a material having a basis weight of from about 0.5 osy (17 gsm) to about 1.5 osy (51 gsm). Lesser or greater basis weights may be used in the other regions of the seat cover 10, as discussed above, in the back side 60. Additionally, the back side 60 or portions thereof, can be made of materials having an abrasion resistant characteristic.

The front side 42 may be any soft and flexible sheet. The front side 42 may permit submersion in liquids, such as fresh water, salt water, and/or treated water (chlorinated or brominated) and still retain its integrity. The front side 42 may comprise, for example, a nonwoven web or sheet of a spunbonded, meltblown, or bonded-carded web composed of synthetic polymer filaments, such as polypropylene, polyethylene, polyesters, or the like, or a web of natural and synthetic fibers or filaments such as cotton and rayon. The front side 42 may be selectively embossed or perforated with discrete slits or holes extending therethrough. Suitable adhesives for adhering the laminate layers can be obtained from Findley Adhesives, Inc. of Wauwatosa, Wis.

The front side 42 may be constructed of a single spunbonded polypropylene nonwoven web having a basis weight of about 0.5 osy (17 gsm) to about 1.5 osy (51 gsm). In the structure of the seat cover 10, the front side 42 desirably comprises a material having a basis weight of from about 0.5 osy (17 gsm) to about 1.5 osy (51 gsm). Lesser or greater basis weights may be used in the other regions of the seat cover 10, as discussed above, in the front side 42. Additionally, the front side 42 or portions thereof, can be made of materials having an abrasion resistant characteristic.

The back side 60 and the front side 42 may be further dyed, pigmented, or imprinted with any suitable color. The back side 60 and the front side 42 may be identical or different. Desirably, the back side 60 is either dyed, pigmented, or printed with a material which does not irritate or bleed the color onto the skin of the user or the backrest 14, seat cushion 16, or any other portion of the vehicle seat 12.

Additionally, the web of fabric 90 may comprise monocomponent or bicomponent spunbond fibers. Generally, methods for making spunbond fiber nonwoven or woven webs of fabric 90 include extruding molten thermoplasic polymer through a spinneret, quenching the filaments, and then drawing the quenched filaments with a stream of high velocity air to form a web of randomly arrayed fibers on a collecting surface or other method of handling to form a woven web of fabric 90. As examples, methods for making the nonwoven webs of fabric 90 are described in U.S. Pat. No. 4,692,618 issued to Dorschner et al.; U.S. Pat. No. 4,340,563 issued to Appel et al.; and, U.S. Pat. No. 3,802,817 issued to Matsuki et al., all of which are incorporated herein by reference.

Monocomponent fibers may be formed from one or more extruders using only one polymer. This is not meant to exclude fibers formed from one polymer to which small amounts of additives have been added for coloration, anti-static properties, lubrication, hydrophilicity, etc. These additives, e.g. titanium dioxide for coloration, are generally present in an amount less than 5 weight percent and more typically about 2 weight percent.

Bicomponent fibers, also referred to as biconsitutuent, conjugate, or multiconstituent fibers, are discussed in, for example, U.S. Pat. No. 5,108,827 issued to Gessner; U.S. Pat. No. 5,108,820 issued to Kaneko et al.; U.S. Pat. No. 5,336,552 issued to Strack et al.; and, U.S. Pat. No. 5,382,400 issued to Pike et al., all of which are incorporated herein by reference. For two component fibers, the polymers may be present in ratios of 75/25, 50/50, 25/75 or any other desired ratios. Such fibers are also discussed in the textbook Polymer Blends and Composites by John A. Manson and Leslie H. Sperling, copyright 1976 by Plenum Press, a division of Plenum Publishing Corporation of New York, IBSN 0-306-30831-2, at pages 273 through 277.

Such multicomponent spunbond fibers may be formed from at least two polymer streams but spun together to form a unitary fiber. The individual components comprising the multicomponent fiber are usually different polymers and are arranged in distinct zones or regions that extend continuously along the length of the fibers. The configuration of such fibers can vary and commonly the individual components of the fiber can be positioned in a side-by-side arrangement, sheath/core arrangement, pie or wedge arrangement, islands-in-sea arrangement and so forth. Multicomponent fibers and methods of making the same are known in the art, an by way of example only, are described in U.S. Pat. No. 5,382,400 issued to Pike et al.; U.S. Pat. No. 5,534,339 issued to Stokes et al.; and, U.S. Pat. No. 5,989,004 issued to Cook, all of which are incorporated herein by reference.

The web of fiber 90 may also comprise hollow fibers as discussed in U.S. patent application filed on Jan. 27, 1999 for Detamore et al. and having the Ser. No. 09/117,382, and U.S. Pat. No. 3,772,137 issued to Tolliver, all of which are incorporated herein by reference.

The seat cover 10 desirably has a basis weight sufficient provide the protection or comfort for which the seat cover 10 is being employed. For example, the basis weight of the fabric 90 should be sufficient to provide a comfortable surface to sit on.

It is also desirable that the seat cover 10 be permeable to air while being hydrophobic. Many of the conventional articles that provide hydrophobic characteristics do so at the expense of permeability. For example, rubber backed seat covers are not comfortable for use in a hot vehicle, since the heat from the rubber is transferred to the passenger or driver.

The seat cover 10 may also be resistant to abrasion. This is important, not only for appearance characteristics, but for the protective characteristics of the seat cover 10. For example, conventional seat covers quickly show wear due to abrasion encounter during normal use, such as when items, or pets, are placed on the seat cover 10. Worn areas are more likely to result in dirt, sand or other foreign materials coming in contact with the user or otherwise providing a less clean and comfortable use. It is also a desirable feature of the seat cover 10 to be colorfast during exposure to sunlight.

It is also desirable for the seat cover 10 to be resistant to pilling and fuzzing for appearance as well as comfort during use. Conventional cloth seat covers are susceptible to pilling and fuzzing. The pilling and fuzzing can create pills on the surface of such seat cover which makes it uncomfortable to sit on.

Due to the various uses that a seat cover 10 may be employed, it is reasonable to expect the seat cover 10 would be laundered. It is desirable that the seat cover 10 be constructed of a fabric 90 that would maintain its dimensions and shape. Many seat covers are not made from a fabric which may be laundered. In addition, sear covers which may be laundered may shrink or otherwise experience dimensional changes. This may result in not only appearance issues of with the seat cover, but may also pose use problems due to the changes in the dimensions of the seat cover.

The seat cover 10 should be able to resist many of the stains that one would expect the seat cover 10 to be exposed during use. In addition, resistance of the seat cover 10 to retaining sand, soil, and other foreign materials as well as water provides better appearance, protection, handling, and storage characteristics.

In some embodiments of a multi-layer seat cover 10, it may be desirable to join the layers together as generally represented in FIG. 8. In addition, it may be desirable to join the layers together only in certain regions (not shown). In such an embodiment, the regions or points of joining may be less than about one (1) inch apart, or may range from about one (1) inch to about thirty six inches apart, from about two (2) inches to about thirty (30) inches apart, from about four (4) inches to about twenty four (24) inches apart, from about six (6) inches to about eighteen (18) inches apart, from about eight (8) inches to about twelve (12) inches apart.

Test Methods

Test Method 1: Basis Weight:

The basis weight of fabric is measured using the ASTM D 3776-96. The testing is performed in standard atmospheric conditions (70±2° C., 65±2% R.H.) using a Mettler Balance (Model B-6) as the testing apparatus. The average basis weight is reported in osy and gsm.

It is desirable that the basis weight of the fabric of the seat cover range between from about 0.15 osy to about 8.0 osy, from about 0.5 osy to about 6.0 osy, from about 0.75 osy to about 5.0 osy, from about 1.0 osy to about 2.2 osy, or about 1.5 osy.

Test Method 2: Air Permeability:

The air permeability of fabric is measured using the ASTM D 737-96. The testing is performed in a conditioned atmosphere in accordance with standard test method procedures (conditions (70±2° C., 65±2 % R.H.) using a High Pressure Differential Air Permeability Machine from Frazier Precision Instrument Co. as the testing apparatus. The average air flow through fabric is reported in ft³/min/ft².

It is desirable that the air permeability of the fabric of the seat cover range between from about 60 ft³/min/ft² to about 110 ft³/min/ft², from about 70 ft³/min/ft² to about 100 ft³/min/ft², from about 80 ft³/min/ft² to about 95 ft³/min/ft², or from about 85 ft³/min/ft² to about 90 ft³/min/ft².

Test Method 3: Abrasion Resistance—Flex:

The abrasion resistance of fabric is measured using the ASTM D 3885-99 in the warp direction of the material/fabric and the ASTM D 3885-99 in the filling direction of the material/fabric. The testing is performed in a conditioned atmosphere in accordance with standard test method procedures (conditions (70±2° C., 65±2% R.H.) using a CSI Stoll QM Universal Wear Tester (Model #CS-22C) with a Flex Abrasion Attachment as the testing apparatus. The apparatus is set at a tension load of 2 lbs. and a balance head load of 0.5 lbs. The average flex resistances in the warp (MD) and filling (CD) directions are reported in the number of cycles required to reach failure.

It is desirable that the abrasion resistance flex of the fabric of the seat cover in the warp direction range between from about 100 cycles to about 300 cycles, from about 150 cycles to about 250 cycles, or about 200 cycles.

It is desirable that the abrasion resistance flex of the fabric of the seat cover in the filling direction range between from about 40 cycles to about 140 cycles, from about 60 cycles to about 130 cycles, from about 80 cycles to about 110, or about 95 cycles.

Test Method 4: Colorfastness to Light:

The colorfastness to light of fabric is measured by exposing the fabric to 40 AATCC fading units of outdoor light and tested for light colorfastness according to the AATCC test method 16-1998. An Atlas C165A Xenon Weather-O-meter (model #C1-65A), set per the test conditions listed in Option E of the AATCC 16-1998 test method, is used as the testing apparatus. Two separate evaluators make visual evaluations of the color change of three specimens of each test fabric. The average colorfastness is reported on a 1-5 scale with 5 representing no color change after exposure to light and 1 representing heavily changed color change when compared to the Gray Scale For Color Change under AATCC Evaluation Procedure 1. The colorfastness to light of the fabric may be also evaluated instrumentally using a HunterLab (LabScan2 0/45) spectrophotometer.

It is desirable that the colorfastness to light of the fabric of the seat cover range between from about 5 to about 4.5, from about 5 to about 4.75, or about 5.

Test Method 5: Pilling Resistance—Random Tumble Method—Fuzz:

The pilling resistance of fabric is tested before laundering according to the ASTM D 3512-99. The test fabric is tested after laundering five times as set forth in the ASTM D 3512-99. Each laundering is performed in a conventional washing machine and dryer at the following settings: Machine Wash, Warm Water Temp, Normal Agitation, and Low Tumble Dry (below 190° F.) using standard AATCC laundry detergent. Testing is performed under standard atmospheric conditions (70±2° C., 65±2% R.H.) using an Atlas Random Tumble Pilling Tester (Model PT-4) as the testing apparatus. The test chamber air pressure injection is set at 2 psi. Two separate evaluators make visual evaluations of the fuzzing resistance of the fabric both before and after laundering five times. The average fuzzing resistance before and after five launderings is reported on a 1-5 scale with 5 representing no pilling or fuzz and 1 representing very severe pilling or fuzz.

It is desirable that the pilling resistance of the unlaundered fabric of the seat cover range between from about 5 to about 3, from about 4.5 to about 3.5, or about 4.0. It is desirable that the pilling resistance of the laundered fabric of the seat cover range between from about 5 to about 3, from about 4.5 to about 3.5, or about 4.0.

It is desirable that the fuzzing resistance of the unlaundered fabric of the seat cover range between from about 5 to about 3, from about 4.5 to about 3.5, or about 4.0. It is desirable that the fuzzing resistance of the laundered fabric of the seat cover range between from about 5 to about 3, from about 4.5 to about 3.5, or about 4.0.

Test Method 6: Dimensional Change in Home Laundering:

The dimensional change during home laundering of fabric is tested after one laundering and after five launderings according to the ASTM D 135-95 in the warp direction of the fabric. The fabric is tested after one laundering and after five launderings as set forth in the ASTM D 135-95 in the filling direction of the fabric/material. Each laundering is performed in a conventional washing machine and dryer at the following settings: Machine Wash, Warm Water Temp, Normal Agitation, and Low Tumble Dry (below 190° F.) using a standard AATCC laundry detergent. The fabric evaluation is performed in standard atmospheric conditions (70±2° C., 65±2% R.H.) The average percent change in dimensions of the fabric is measured after one laundering and after five launderings.

It is desirable that the dimensional change after one home laundering abrasion of the fabric of the seat cover in the warp direction range between from about 2.0% to about 3.0%, from about 2.25% to about 2.75%, or about 2.5%. It is desirable that the dimensional change after five home laundering abrasion of the fabric of the seat cover in the warp direction range between from about 3.5% to about 4.5%, from about 3.75% to about 4.25%, or about 4.0%.

It is desirable that the dimensional change after one home laundering abrasion of the fabric of the seat cover in the filling direction range between from about 1.5% to about 3.0%, from about 2.0% to about 2.75%, or from about 2.25% to about 2.5%. It is desirable that the dimensional change after five home laundering abrasion of the fabric of the seat cover in the filling direction range between from about 3.0% to about 4.0%, from about 3.25% to about 3.75%, or about 3.5%.

Test Method 7: Stain Resistance:

The stain resistance of fabric to the following stains is determined using the following materials:
Tea: Luzianne Tea, Reily Foods Company, New Orleans, La. 70130.
Blueberry: Best Yet Frozen Blueberries, Fleming Companies, Inc, Oklahoma City, Okla. 73126.
Beef Blood: Obtained from butcher.
Wine: Sutter Home Cabernet Sauvignon wine.
Instant Coffee: HyVee Instant Coffee, HyVee, Inc., 5820 Westown Parkway, West Des Moines, Iowa 50265.
Mustard: Classic Yellow French's Mustard, Rickett & Colman Inc., Montvale, N.J. 07645.
Gravy: Best Yet Homestyle Brown Gravy Mix, Fleming Companies, Inc., Oklahoma City, Okla. 73126.
Chocolate Syrup: Critic's Choice Chocolate Flavored Syrup, Amway Corp., Ada, Mich, 49355-0001.
Grape Juice: Juicy Juice Grape Juice, Nestle USA, Beverage Division, Inc., Glendale, Calif. 91203.
Clay: Claystone Grey Self-hardening Modeling Clay, Standard Clay Mines, 100 Camp Meeting Avenue, Skillman, N.J. 08558.
Ketchup: Extra Thick Critic's Choice Tomato Ketchup, Amway Corp., Ada, Mich. 49355-0001.

The fabrics are exposed to the above materials and laundered five times according per ASTM D 4265-98. Each laundering is performed in a conventional washing machine and dryer at the following settings: Machine Wash, Warm Water Temp, Normal Agitation, and Low Tumble Dry (below 190° F.) using a standard AATCC laundry detergent. Two separate evaluators (ASTM D 4265-98 stipulates three evaluators) make visual evaluations of the stain resistance of the fabric to the above materials. The average stain resistance of the fabric to each material is reported on a 1-5 scale with 5 representing no residue stain after five launderings and 1 representing residual stain equivalent to Replica 1 when compared to AATCC Stain Release Replica available from AATCC, Research Triangle Park, N.C.

It is desirable that the stain resistance to tea of the laundered fabric of the seat cover range between from about 4 to about 5, from about 4.5 to about 5, or is 5.

It is desirable that the stain resistance to blueberry of the laundered fabric of the seat cover range between from about 4 to about 5, from about 4.5 to about 5, or is 5.

It is desirable that the stain resistance to beef blood of the laundered fabric of the seat cover range between from about 4 to about 5, from about 4.5 to about 5, or is 5.

It is desirable that the stain resistance to wine of the laundered fabric of the seat cover range between from about 4 to about 5, from about 4.5 to about 5, or is 5.

It is desirable that the stain resistance to instant coffee of the laundered fabric of the seat cover range between from about 4 to about 5, from about 4.5 to about 5, or is 5.

It is desirable that the stain resistance to mustard of the laundered fabric of the seat cover range between from about 4 to about 5, from about 4.5 to about 5, or is 5.

It is desirable that the stain resistance to gravy of the laundered fabric of the seat cover range between from about 4 to about 5, from about 4.5 to about 5, or is 5.

It is desirable that the stain resistance to chocolate syrup of the laundered fabric of the seat cover range between from about 4 to about 5, from about 4.5 to about 5, or is 5.

It is desirable that the stain resistance to grape juice of the laundered fabric of the seat cover range between from about 4 to about 5, from about 4.5 to about 5, or is 5.

It is desirable that the stain resistance to clay of the laundered fabric of the seat cover range between from about 4 to about 5, from about 4.5 to about 5, or is 5.

It is desirable that the stain resistance to ketchup of the laundered fabric of the seat cover range between from about 4 to about 5, from about 4.5 to about 5, or is 5.

Test Method 8: Colorfastness to Laundering:

The colorfastness to laundering is measured per AATCC test method 61-1996. An Atlas Launder-O-meter (model #LEF) is used to accelerate laundering the test fabrics. The conditions of testing are set per test number 2A in AATCC test method 61-1996: 49° C. (120° F.); 150 mL liquor volume; 0.15% detergent solution; 50 steel balls; time period of 45 minutes; one pass through wringer; and, tumble dry (below 190° F.). The conditions simulates five home machine launderings at medium or warm setting in the temperature range of 38±3° C. (100±5° F.). Two separate evaluators make visual evaluations of the color change of the test fabric. The colorfastness to light of the fabric may be also evaluated instrumentally using a HunterLab (LabScan2 0/45) spectrophotometer. The average colorfastness of the test fabric is reported on a 1-5 scale with 5 representing no color change after laundering and 1 representing heavily changed color change when compared to the Gray Scale For Color Change under AATCC Evaluation Procedure 1.

It is desirable that the colorfastness to light of the fabric of the seat cover range between from about 5 to about 4.5; from about 5 to about 4.75, or about 5.

Test Method 9: Hydrostatic Water Resistance:

The hydrostatic water resistance (resistance to the penetration of water under low hydrostatic pressure of fabric is measured according to a Kimberly-Clark standard test method 4492. The two layers of nonwoven material are layered together so that the formation sides of each layer were touching each other (non-formation sides out). The two layers of test fabric are not stitched together. An Expulsion Press Die-Cutter with dies (TMI DGD, K-C item number 832561, part number 22-16-00) from Testing Machines, Inc. is used to cut six (6) inch diameter circular test fabric pieces.

Each six inch diameter pieces of the test fabric are mounted on a TEXTES FX-3000 hydrostatic head tester (K-C item number 851229, part number FX-3000) form clamped down on the test head reservoir. The test fabric pieces are placed over the test head and clamped down so that a proper seal is formed with the test head around the entire edge of the test fabric pieces. The large, 100 cm² test head, filled to the rim with purified water at 75±10° F., is used for this test method. The test fabric piece is then subjected to a standardized water pressure, which was increased at a constant rate. The resistance of the test fabric to the water pressure is measured in millibars as the hydrostatic head height reaches the first sign of leakage in three separate areas on the test specimen. A higher millibar value indicates greater resistance to water penetration. The hydrostatic water resistance is measured at hydrostatic head height in millibars.

It is desirable that the hydrostatic water resistance of the fabric of the seat cover range between from about 45.0 to about 55.0 millibars; from about 48.0 to about 54.0 millibars; from about 49.0 to about 53.0 millibars; from about 50.0 to about 52.0 millibars; or about 51.5 millibars.

While the present invention has been described in connection with certain preferred embodiments it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

1. A washable, stain-resistant vehicle seat cover, comprising:
an upper portion configured to cover a portion of a backrest;
a lower portion configured to cover a portion of a seat cushion;
a first and second elasticized flap, each flap positioned near a lateral edge of a junction of a backrest and a seat cushion, the flaps cooperating to define a containment area therebetween.

2. The washable, stain-resistant vehicle seat cover of claim 1, wherein the seat cover is formed from a nonwoven fabric.

3. The washable, stain-resistant vehicle seat cover of claim 2, wherein the nonwoven fabric has a stain resistance from about 4 to about 5 for blueberry, instant coffee, gravy, wine, tea, clay, ketchup, beef blood, mustard, chocolate syrup, and grape juice.

4. The washable, stain-resistant vehicle seat cover of claim 2, wherein the nonwoven fabric has a colorfastness to light from about 4.5 to about 5.

5. The washable, stain-resistant vehicle seat cover of claim 2, wherein the nonwoven fabric has a pilling reistance before laundering from about 3 to about 5 and a pilling resistance after laundering from about 3 to about 5.

6. The washable, stain-resistant vehicle seat cover of claim 2, wherein the nonwoven fabric has dimensional chage after one laundering of about 3.0 percent or less and a dimensional change after five launderings of about 4.5 percent or less.

7. The washable, stain-resistant vehicle seat cover of claim 2, wherein the nonwoven fabric has an abrasion resistance flex in the warp direction from about 100 cycles to about 300 cycles and an abrasion resistance flex in the filling direction from about 40 cycles to about 140 cycles.

8. The washable, stain-resistant vehicle seat cover of claim 2, wherein the nonwoven fabric has a colorfastness to laundering from about 4.5 to about 5.

9. The washable, stain-resistant vehicle seat cover of claim 2, wherein the nonwoven fabric has a hydrostatic water resistance from about 4.5 millibars to about 55.0 millibars.

10. The washable, stain-resistant vehicle seat cover of claim 2, wherein the fabric comprises more than one layer.

11. The washable, stain-resistant vehicle seat cover of claim 10, wherein at least one layer includes nonwoven material.

12. The washable, stain-resistant vehicle seat cover of claim 10, wherein the layers each comprise different fabrics.

13. The washable, stain-resistant vehicle seat cover of claim 1, wherein each of the elasticized flaps is elasticized by at least one tension elastic member applied thereto.

14. The washable, stain-resistant vehicle seat cover of claim 13, wherein the at least one elastic member is applied to each of the flaps with a first preselected tension.

15. The washable, stain-resistant vehicle seat cover of claim 14, wherein the first preselected tension is sufficient to cause a substantial portion of each flap to be supported in an upright position and extend away from the vehicle seat cover when the vehicle seat cover is positioned on a vehicle seat.

16. The washable, stain-resistant vehicle seat cover of claim 15, wherein each flap in the upright position provides a barrier which is configured to provide at least a portion of the containment area.

17. The washable, stain-resistant vehicle seat cover of claim 15, wherein each flap is positioned at an angle of about 25 degrees to about 120 degrees with respect to a centerline of the vehicle car seat.

18. The washable, stain-resistant vehicle seat cover of claim 17, wherein each flap is positioned at an angle of about 40 degrees to about 100 degrees with respect to a centerline of the vehicle car seat.

19. The washable, stain-resistant vehicle seat cover of claim 15, wherein each flap has at least a second elastic member applied thereto.

20. The washable, stain-resistant vehicle seat cover of claim 19, wherein the second elastic member is applied adjacent the first elastic member, and the second elastic member includes a second preselected tension, the second preselected tension configured to be one of greater than, less than and equal to the first preselected tension.

21. The washable, stain-resistant vehicle seat cover of claim 20, wherein the second elastic member cooperates with the first elastic member to cause a substantial portion of each flap to extend away from the vehicle seat cover when the vehicle seat cover is applied to a vehicle seat.

22. The washable, stain-resistant vehicle seat cover of claim 1, wherein each flap is integrally formed with the vehicle seat cover.

23. The washable, stain-resistant vehicle seat cover of claim 1, wherein each flap is formed separately and connected to the vehicle seat cover.

24. A washable, stain-resistant vehicle seat cover, comprising:
an upper portion configured to cover a portion of a backrest; and
a lower portion configured to cover a portion of a seat cushion;
wherein the vehicle seat cover is formed from a nonwoven fabric which has a basis weight from between about 0.15 osy to about 8.0 osy, an air permeability from about 60 ft³min/ft² to about 110 ft³min/ft², and a stain resistance from about 4 to about 5 for blueberry, instant coffee, gravy, and wine.

25. The washable, stain-resistant vehicle seat cover of claim 24, wherein the nonwoven fabric has a stain resistance from about 4 to about 5 for tea, clay, ketchup, beef blood, mustard, chocolate syrup, and grape juice.

26. The washable, stain-resistant vehicle seat cover of claim 24, wherein the nonwoven fabric has a colorfastness to light from about 4.5 to about 5.

27. The washable, stain-resistant vehicle seat cover of claim 24, wherein the nonwoven fabric has a pilling resistance before laundering from about 3 to about 5 and a pilling resistance after laundering from about 3 to about 5.

28. The washable, stain-resistant vehicle seat cover of claim 24, wherein the nonwoven fabric has dimensional change after one laundering of about 3.0 percent or less and a dimensional change after five launderings of about 4.5 percent or less.

29. The washable, stain-resistant vehicle seat cover of claim 24, wherein the nonwoven fabric has an abrasion resistance flex in the warp direction from about 100 cycles to about 300 cycles and an abrasion resistance flex in the filling direction from about 40 cycles to about 140 cycles.

30. The washable, stain-resistant vehicle seat cover of claim 24, wherein the nonwoven fabric has a colorfastness to laundering from about 4.5 to about 5.

31. The washable, stain-resistant vehicle seat cover of claim 24, wherein the nonwoven fabric has a hydrostatic water resistance from about 4.5 millibars to about 55.0 millibars.

32. The washable, stain-resistant vehicle seat cover of claim 24, wherein the seat cover includes a pair of spaced-apart elasticized flaps, each flap elasticized by at least one tension elastic member applied thereto, and wherein the at least one elastic member is applied to each of the flaps with a first preselected tension.

33. The washable, stain-resistant vehicle seat cover of claim 32, wherein the first preselected tension is sufficient to cause a substantial portion of each flap to extend away from the vehicle seat cover when the vehicle seat cover is positioned on a vehicle seat.

34. The washable, stain-resistant vehicle seat cover of claim 32, wherein each flap has at least a second elastic member applied thereto, and wherein the second elastic member is applied adjacent the first elastic member, and the second elastic member includes a second preselected tension, the second preselected tension configured to be one of greater than, less than and equal to the first preselected tension.

35. The washable, stain-resistant vehicle seat cover of claim 34, wherein the second elastic member cooperates with the first elastic member to cause a substantial portion of each flap to extend away from the vehicle seat cover when the vehicle seat cover is applied to a vehicle seat.

36. The washable, stain-resistant vehicle seat cover of claim 32, wherein each flap is integrally formed with the vehicle seat cover.

37. The washable, stain-resistant vehicle seat cover of claim 32, wherein each flap is formed separately and connected to the vehicle seat cover.

38. A washable, stain-resistant vehicle seat cover, comprising:
an upper portion configured to cover a portion of a backrest;
a lower portion configured to cover a portion of a seat cushion;
a pair of elasticized flaps which therebetween define a containment area,
wherein the vehicle seat cover is formed from a nonwoven fabric which has a basis weight from between about 0.15 osy to about 8.0 osy, an air permeability from about 60 ft³min/ft² to about 110 ft³min/ft², and a stain resistance from about 4 to about 5 for blueberry, instant coffee, gravy, and wine.
